(19) United States
(12) Patent Application Publication
(10) Pub. No.: US 2022/0373103 A1
(43) Pub. Date: Nov. 24, 2022

(54) Replaceable Tube Route Labeling With Color Coded Fitments

(71) Applicants: James A. Austin, Fort Worth, TX (US); Jeffrey O. Getrum, Fort Worth, TX (US)

(72) Inventors: James A. Austin, Fort Worth, TX (US); Jeffrey O. Getrum, Fort Worth, TX (US)

(73) Assignee: ConeCraft, Inc., Fort Worth, TX (US)

(21) Appl. No.: 17/324,763

(22) Filed: May 19, 2021

(51) Int. Cl. F16L 3/22

(52) U.S. Cl. CPC F16L 3/221

(57) ABSTRACT

System and method for route-labeling a process fixture to assist installation of plural tubes, where the process fixture includes plural support plates cooperatively arranged. A first bracket is fixed to a first support plate, and plural tube clips are selectively attached to the first bracket, where each of the plural tube clips displays a unique color to distinguish one from another. A first route-indicator is disposed elsewhere on the process fixture, which displays a first color selected from the plural unique colors that matches a first one of the plural tube clips according to color, and which enables routing a first tube of the plural tubes according to the first color.

### BACKGROUND OF THE INVENTION

### Related Applications

None.

### Field of the Invention

The present invention relates to single use tube routing and support equipment. More particularly, the present invention relates to systems and methods for route labeling process tubing system using color coded fitments.

### DESCRIPTION OF THE RELATED ART

In many industry and pharmaceutical applications, there is a need for fluid transfer where the transferred fluid must be carefully handled so as not to compromise fluid purity or physical, chemical, and pharmaceutical characteristics. One common issue in such applications is the need to maintain the cleanliness of the tubing, vessels, pumping equipment, and other devices. Of course, the cost for equipment, labor, and production time must always be considered in design and implementation of such systems. Additionally, such systems may need to be reconfigured from time to time to satisfy the requirements of particular products in production. By way of example, the biopharmaceutical industry is shifting to more single use equipment to reduce cost and increase flexibility in the manufacturing processes. Experience in industry has demonstrated that cleaning and sterilization processes, as well as validation and maintenance of such systems, can be significantly more expensive than utilizing single use equipment, where sanitation and cleanliness are initially reset with each fresh installation.

Where a complex system is deployed, there can be a large number of tubes routed to an every larger number of connection points, such as vessels, pumps, valves, filter, and other equipment. Generally, polymeric tubing is preferred in such applications because of its flexibility in installation, inert chemical characteristics, and lowered cost though bulk purchasing. This approach results in a large number of visually identical tubes routed about a complex set of process equipment, which arrangement is ripe for installation miss-connections and subsequent testing and production issues.

In addition to routing tubes between various connection points, there is also a need to position and support the tubing in an organized manner. Tray, clips, end connectors, and various other support members have been utilized to organize and support such tubing. The design and set-up of such support fixtures can be complex, and in combination with the aforementioned routing issues, it can thusly be appreciated that there is need in the art of mitigating the problems in the prior art.

### SUMMARY OF THE INVENTION

The need in the art is addressed by the systems and methods of the present invention. The present disclosure teaches a system for route labeling a process fixture to assist installation of plural tubes thereupon, where the process fixture includes plural support plates cooperatively arranged to support the plural tubes. The system includes a first bracket fixed to a first support plate, and plural tube clips selectively attached to the first bracket, where each of the plural tube clips displays one of plural unique colors to distinguish one from another. A first route indicator is disposed elsewhere on the process fixture, which displays a first color selected from the plural unique colors that matches a first tube clip selected from the plural tube clips according to color, which enables routing a first tube from the plural tubes according to the first color.

In a specific embodiment of the foregoing system, the first route indicator is a second tube clip attached to a second bracket fixed elsewhere to the process fixture, which also displays the first color, and the first tube is engaged with the first tube clip and the second tube clip, according to the matching color.

In a specific embodiment of the foregoing system, the first route indicator is a route marker, which also display the first color, and the first route marker is fixed to the process fixture along a planned route of the first tube.

In a specific embodiment of the foregoing system, the route marker is fabricated from a polymeric material having a stem, which is inserted through a hole the process fixture, and stem engages the hole, thereby retaining the route marker in place on the fixture.

In a specific embodiment of the foregoing system, the first route indicator is a tube ring, which also displays the first color, and which is engaged about an exterior surface of the first tube, to thereby identify the color routing for that tube.

In a specific embodiment of the foregoing system where, the plural tube clips include mounting holes, the plural tube clips are attached to the first bracket with a fastener inserted through the mounting holes. In a refinement to this embodiment, the fastener is a ball detent pin fixed to the first bracket, which facilitates quick connection of the tube clip to the bracket.

In a specific embodiment of the foregoing system, the first bracket engages a slotted opening in the first support plate, which thereby presents the plural tube clips through the slotted opening in a manner that the plural tubes lie substantially flush with a support surface of the first support plate.

In a specific embodiment of the foregoing system, the plural tube clips fabricated from a polymeric material. In a refinement to this embodiment, the polymeric material is silicone rubber or high density polyethylene.

In a specific embodiment of the foregoing system, the first bracket is substantially linear, and the plural tube clips are arranged side-to-side along the first bracket such that plural tubes supported thereby are arranged in parallel.

In a specific embodiment of the foregoing system, the first bracket is circular, and disposed about a hole in the first support plate, such that the plural tubes pass through the hole in the first support plate.

The present disclosure also teaches a method of route labeling a process fixture that includes plural support plates, so as to assist installation of plural tubes thereupon, and which employs brackets, plural tube clips each displaying a unique color, and route indicators also displaying a unique color. The method includes attaching a first bracket to a first support plate, selecting a first tube clip according to a first color, and attaching the first tube clip to the first bracket. Then, selecting a first route indicator according to the first color, and attaching the first route indicator to the process fixture. Then, engaging a first tube with the first tube clip and routing the first tube about the process fixture to the first route indicator according to the first color, thereby providing route labeling for the first tube according to the first color.

In a specific embodiment of the foregoing method, where the first route indicator is a second tube clip, which also displays the first color, the method further includes attaching a second bracket to the process fixture, attaching the second tube clip to the second bracket, and engaging the first tube with the first tube clip and the second tube clip.

In a specific embodiment of the foregoing method, where the first route indicator is a route marker, which also display the first color, the method further includes attaching the first route marker to the process fixture along a planned route of the first tube, and routing the first tube along the first route marker according to the first color.

In a specific embodiment of the foregoing method the route marker is fabricated from a polymeric material having a stem, and the method further includes inserting the stem of the route market through a hole the process fixture.

In a specific embodiment of the foregoing method, where the first route indicator is a first tube ring, which also displays the first color, the method further includes engaging the first tube ring about an exterior surface of the first tube.

In a specific embodiment of the foregoing method, where a slotted opening is formed through the first support plate, the method further includes engaging the first bracket in the slotted opening, thereby presenting the plural tube clips through the slotted opening in a manner that the plural tubes lie substantially flush with a support surface of the first support plate.

In a specific embodiment of the foregoing method, where the first bracket is substantially linear, the method further includes arranging the plural tube clips side-to-side along the first bracket such that plural tubes supported thereby are arranged in parallel.

In a specific embodiment of the foregoing method, where the first bracket is circular and located about a hole in the first support plate, the method further includes installing the plural tube clips around the circular hole in the first support plate, such that the plural tubes pass through the hole in the first support plate.

### BRIEF DESCRIPTION OF THE DRAWINGS

FIG. 1 is a perspective view drawing of a tube support and routing system according to an illustrative embodiment of the present invention.

FIG. 2 is a perspective view drawing of a 45° corner support fixture according to an illustrative embodiment of the present invention.

FIGS. 3A and 3B are a perspective view drawing, and a detail drawing, respectively, of a tee-junction support fixture according to an illustrative embodiment of the present invention.

FIG. 4 is a perspective view drawing of a tube support tray according to an illustrative embodiment of the present invention.

FIG. 5 is a perspective view drawing of a 90° corner tray support fixture according to an illustrative embodiment of the present invention.

FIGS. 6A, 6B and 6C are a top view, and two side view drawings, respectively, of a 90° concert tray support fixture according to an illustrative embodiment of the present invention.

FIG. 7 is a perspective view drawn of a tube support bracket assembly according to an illustrative embodiment of the present invention.

FIG. 8 is an end view drawing a tube support clip according to an illustrative embodiment of the present invention.

FIG. 9 is an end view drawing of a tube marking ring according to an illustrative embodiment of the present invention.

FIGS. 10A, 10B, and 10C are a side view drawing, and end view drawing, and a top view drawing, respectively, of a tube support bracket assembly according to an illustrative embodiment of the present invention.

FIG. 11 is a perspective view drawing of a polymeric tube clip according to an illustrative embodiment of the present invention.

FIG. 12 is a perspective view drawing of a through-wall tube support fixture according to an illustrative embodiment of the present invention.

FIGS. 13A and 13B are a side view drawing and a section view drawing, respectively, of a through-wall tube bracket assembly according to an illustrative embodiment of the present invention.

FIGS. 14A and 14B are a side view drawing and section view drawing, respectively, of a doorway tube holder assembly according to an illustrative embodiment of the present invention.

FIG. 15 is an exploded view drawing of a doorway tube holder according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof, and additional fields in which the present invention would be of significant utility.

In considering the detailed embodiments of the present invention, it will be observed that the present invention resides primarily in combinations of steps to accomplish various methods or components to form various apparatus and systems. Accordingly, the apparatus and system components, and method steps, have been represented where appropriate by conventional symbols in the drawings, showing only those specific details that are pertinent to understanding the present teachings so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

The use of flexible tubing in production and process equipment is widespread. This is particularly the case in pharmaceutical, chemical, biologic, and other production operations that require the flow of fluids within a process environment. The present disclosure was conceived in the pharmaceutical industry, however the teachings herein are of significant utility in a far wider range of applications, as will be come apparent upon review of the present disclosure.

In pharmaceutical applications, the requirements of purity and sanitation, as well as contamination avoidance, are critical. As discussed hereinbefore, this has led to increasing use of single-use tubing regimes, where factory-fresh tubing is installed for each new production run of pharmaceutical products. This involves the installation of a large number of tubes, which are connected to various process fixtures and fittings. These are often complex systems, where errors in installation and connections run at considerable risk. Operating such a process with any misconnected tube can be highly problematic, if not disastrous. Since tubing in generally purchased in bulk, it is typically uniform in color, frequently clear, translucent or white. Thus, at the time of installation, all of the tubing appears identical, except for their diameters. In pharmaceutical application, diameters usually range in size from ¾″ to ¾″ outside diameter in ⅛″ graduations (i.e. ¼″, ⅜′, ½″, ⅝″, and ¾″), although other sizes, including metric sizes are known).

As tubing is routed within a process environment, from point to point, it requires some form of support and position control along its length, particularly important during process operations where the weight and dynamics of fluid flow impact the tube placement. Thus, it is known in the art to provide tube support fixtures, including horizontal trays, vertical, or near vertical, support plates, sometimes with integrated tubing shelves, and tubing attachment clips.

The present disclosure teaches the structure and use of a color coding system that serves to greatly reduce the likelihood of misconnected tubing. These teachings provide for the use of color coded tube clips, color coded tube route markers, which attache to tube support fixture along the preplanned tube route, and color coded tube markers in the form of tube right that grip the exterior of the tubes. Tube markers are useful con placement at the ends of tube runs, as well as along the length of individual tube lengths. These color coded figments are easily attached and arranged, as well as reattached and rearranged. Any number of color options can be employed, and in an exemplary embodiment the available colors are red, orange, yellow, green, blue, violet, gray, and black. Other good choices include magenta and cyan, as all of the forgoing colors are readily distinguishable from on another. These fitments can be fabricated from a variety of materials, and can have color applied thereto through various means. Silicone rubber and UHMW polyethylene are good options as they can be impregnated with color at the time they are molded. However, color tokens and colored paint can be applied to fitments of any material, including virtually all polymeric and metallic materials.

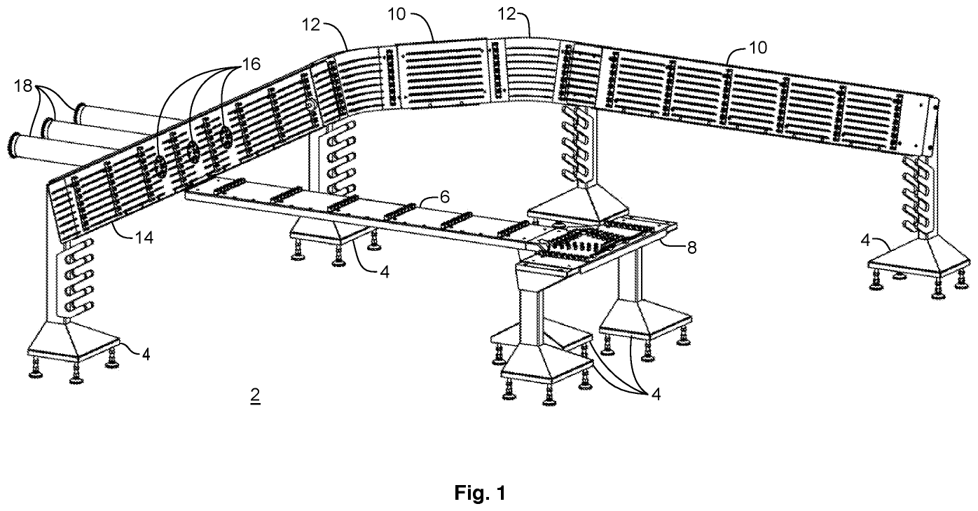

Reference is directed to FIG. 1, which is a perspective view drawing of a tube support and routing system 2 according to an illustrative embodiment of the present invention. This is an exemplary system showing a number of support fixtures, however, it is not meant to represent all of the types of fixtures that may be useful in any given process set-up. This system 2 is supported on plural support stands 4, which support plural tube support trays 6, 8 and plural tube support plates 10, 12, 14, and other fitments, as will be more fully discussed hereinafter. In this disclosure, a support tray is a support structure where gravity causes the tubes to rest naturally on its support surface, which is substantially horizontal. A tube support plate does not. A tube support plate is generally vertical, but often times inclined a fee degrees, and provides plural tubing shelves that include a substantially horizontal surface on which the tubing rests. The plates are typically inclined from vertical so that the tubing is naturally retained. Also note that in this disclosure, the tubing itself is generally not depicted in the drawings, so as not to obscure the details the of the fixtures and support members.

In FIG. 1, a horizontal tray 6 extends to a tee junction tray 8, where tubing can be routed in plural directions, and where tubing tee connections may be employed to route fluids in plural directions. FIG. 1 also illustrate vertical tubing support plates 10 and tubing support interior 45° dinners 12. A specialized through-wall plate 14 is also illustrated, which proved through wall tubes 18 and tube clip ports 16, which will be more fully discussed hereinafter.

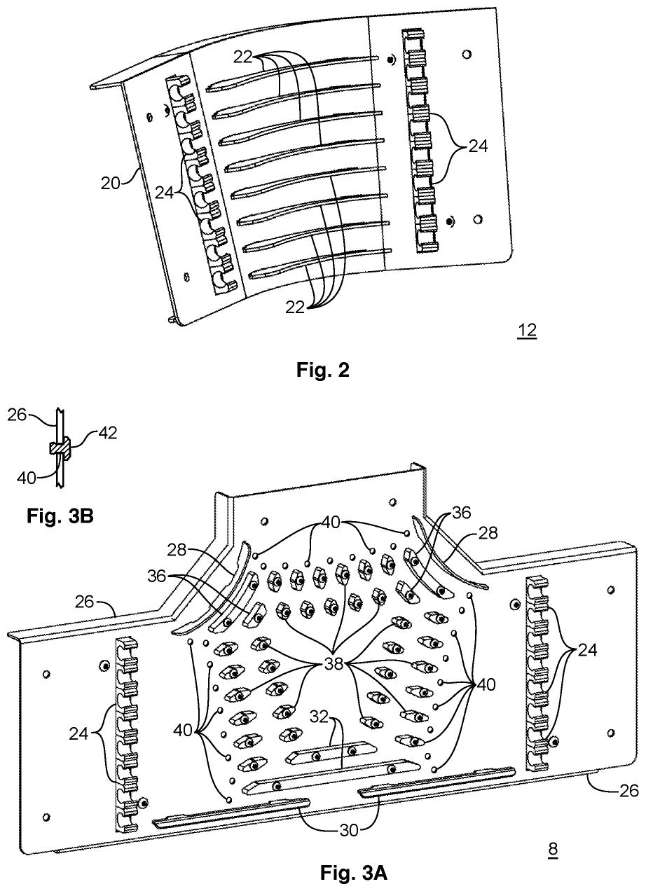

Reference is directed to FIG. 2, which is a perspective view drawing of a 45° corner support plate fixture 12 according to an illustrative embodiment of the present invention. The plate portion 20 is formed of metal or other suitable material, and includes plural tubing shelves 22, as illustrated. A pair of color coded tube support bracket assemblies 24 are also provided, which extend thought the plate 20 such that tubes inserted into them will lay flush with the front surface of the plate and lie upon the shelves 22. The bracket assemblies 24 comprises individually color coded tube clips, as will be more fully discussed hereinafter.

Reference is directed to FIGS. 3A and 3B, which are a perspective view drawing, and a detail section drawing, respectively, of a tee-junction support tray fixture 8 according to an illustrative embodiment of the present invention. In some process systems, it is necessary to route tubing in plural directions, and the tee-junction 8 provides for three directions. The tee-junction 8 is formed of plate material 26, as illustrated. A pair of tube clip bracket assemblies 24 are provided to grip and retain the tubes (not illustrated) using color coded tube clips. Guide rails 28, 30 define the limits for tube placement on the tee junctions 8. Plural guide bosses 38 are arranged about the surface of the plate 26, so as to guide and separate the plural tubes (not illustrated) from one another. Note that a plurality of holes 40 are formed through the plate, and aligned along the spaced between the guide bosses 38, positioned along the several routes that tubes may be laid upon. Color-coded route markers 42 are inserted through these holes 40 to indicate to the installer, where tubes are to be laid. FIG. 3B is a section view detail of a single route marker 42 installed through a single hole 40 in the plate 26. The route markers 42 are each fabricated from one of several uniquely colored polymeric material with a stem that engages the hole 40 to retain it in place. The unique color options are shared amongst the clips and markers to coordinate installation of each tubing route.

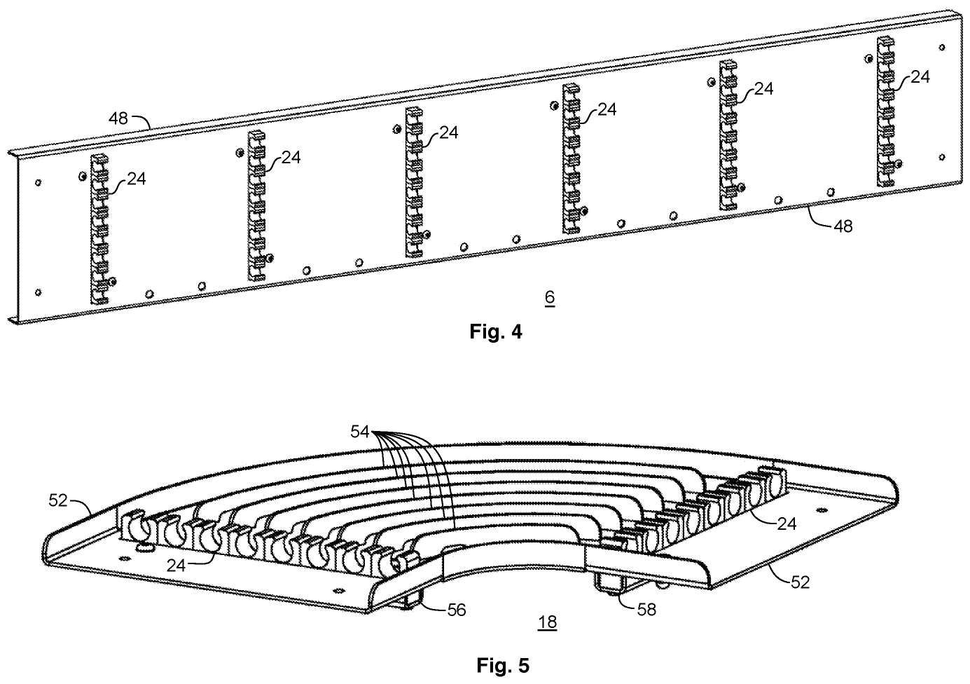

Reference is directed to FIG. 4, which is a perspective view drawing of a tube support tray 6 according to an illustrative embodiment of the present invention. The tray is generally installed in a horizontal orientation (see FIG. 1) so that the tubes (not illustrated) lie upon its surface 48. Along that surface 48 are plural tube clip bracket assemblies 24, which extend thought rectangular openings in the tray 48 such that tubes inserted into them will lie flush with the upper surface of the tray 48. The bracket assemblies 24 comprises unique, individually color coded tube clips.

Reference is directed to FIG. 5, which is a perspective view drawing of a 90° corner tray 18 support fixture according to an illustrative embodiment of the present invention. The corner tray fixture 18 facilitates the orderly routing of plural tubes (not illustrated) about a 90° turn. The tray fixture 18 is fabricated from a plate 52, as illustrated. Plural arcuate ribs 54 are aligned about the 90° turn to guide and organize the plural tubes (not illustrated). At both ends of the 90° turn are tube clip bracket assemblies 24, which extend thought rectangular openings in the tray plate 5 48 such that tubes inserted into them will lie flush with the upper surface of the tray fixture 18. The bracket assemblies 24 comprises unique, individually color coded tube clips.

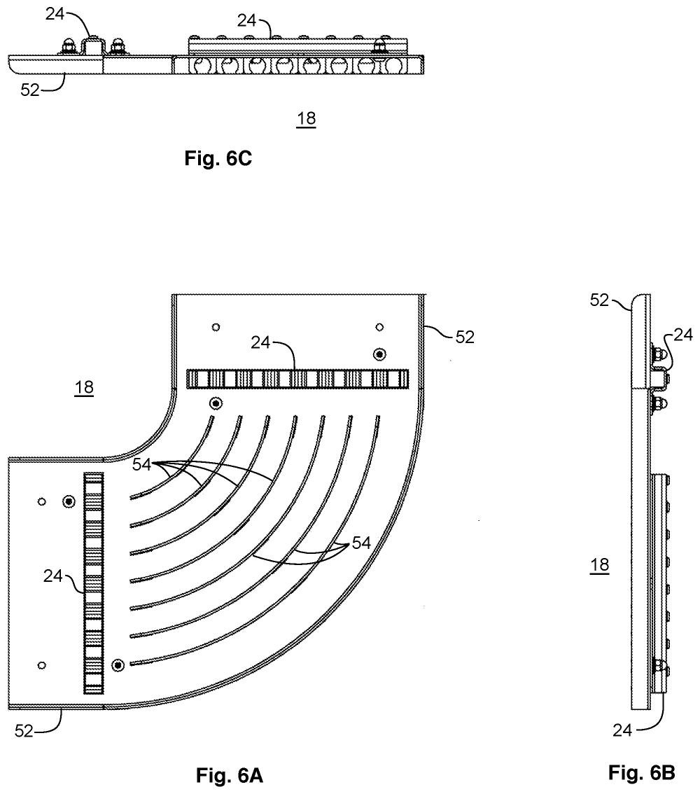

Reference is directed to FIGS. 6A, 6B and 6C, which are a top view, and two side view drawings, respectively, of a 90° corner tray support fixture 18 according to an illustrative embodiment of the present invention. These views provide a clearer representation of how the pair of tube clip bracket assemblies 24 interface with the 90° plate 52. The bracket assemblies hang below the plate 52 and retain the tube clips (described more fully hereinafter) such that the extend through to the upper surface of the plate 52. In this manner, the tubes (not illustrated) lie upon the upper surface, and are properly guided by the plural arcuate ribs. The details of the tube clip bracket assemblies 24 and their fasteners will me more fully described hereinafter.

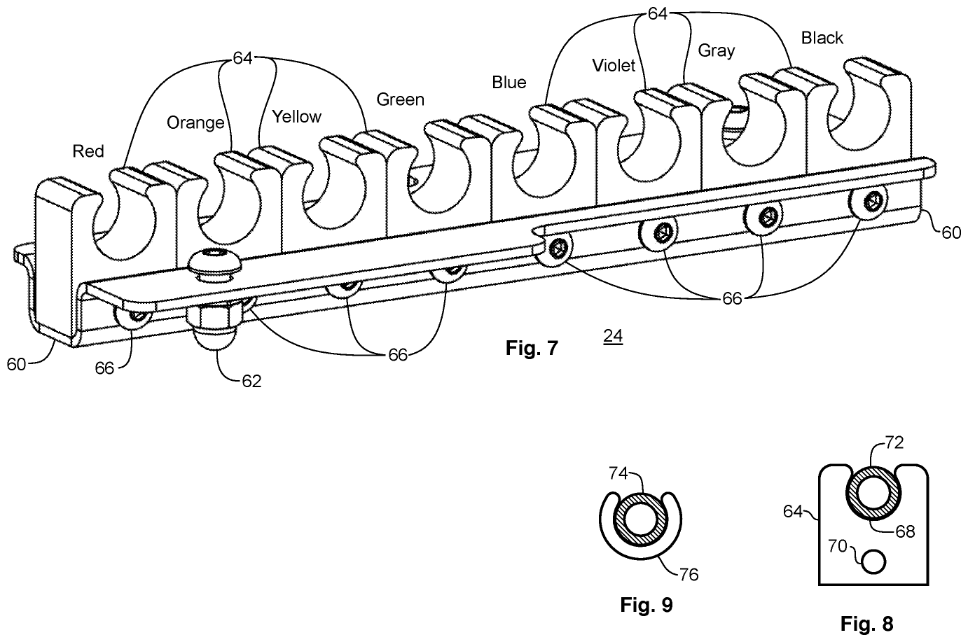

Reference is directed to FIG. 7, which is a perspective view drawn of a tube support bracket assembly 24 according to an illustrative embodiment of the present invention. The assembly 24 includes a formed channel 60, which is fabricated from stainless steel sheet in the illustrative embodiment. Other materials may be employed to fabricate the formed channel, inclined other metals and polymeric materials, including molded and extruded shapes. Plural retention fasteners 66 are inserted through the formed channel 60 and engage plural tube clips 64, which are oriented to route plural tubes (not illustrated) in parallel. The plural tube clips 64 are fabricated from a polymeric material, such as silicone rubber or UHMW polyethylene, which are each impregnated with a unique color. In this embodiment the colors are red, orange, yellow, green, blue, violet, gray, and black. The colors may be placed in any order, which is dictated by a preplanned tube routine map that accommodates the particular process. The formed channel 60 is retained in a support fixture by plural fasteners 62. In this embodiment, the several fasteners 62, 66 are a socket head cap screws and acorn nuts, also referred to as crown hex nuts, that have a domed end on one side.

Reference is directed to FIG. 8, which is an end view drawing of a tube support clip 64 according to an illustrative embodiment of the present invention. Each tube clip 64 includes a tube grip recess 68 into which a tube 72 is inserted. The resilience of the tube 72 and/or the tube clip 64 enable insertion and retention of the tube 72 in the tube recess 68. Each tube clip 64 also includes a mounting hole 70 that a corresponding fastener is inserted through (see item 66 in FIG. 7). In one embodiment, the cap screws and acorn nuts are replaced with ball detent pins that enable instant removal of individual tube clips 64 without the use of tools.

Reference is directed to FIG. 9, which is an end view drawing of a tube marking ring 76 according to an illustrative embodiment of the present invention. The foregoing tube clip assembly provides a color indication of where tubes may be inserted into the fixture system. In addition, the present disclosure contemplates making the tubing itself using a tube ring 76 into which the tube 74 is inserted. The tube rings 76 are fabricated from a polymeric material, such as silicone rubber or UHMW polyethylene, which are each impregnated with a unique color. In this embodiment the colors are red, orange, yellow, green, blue, violet, gray, and black. The tubes are thusly marked with a unique color, which facilitates accurate insertion of the tube into the fixture systems.

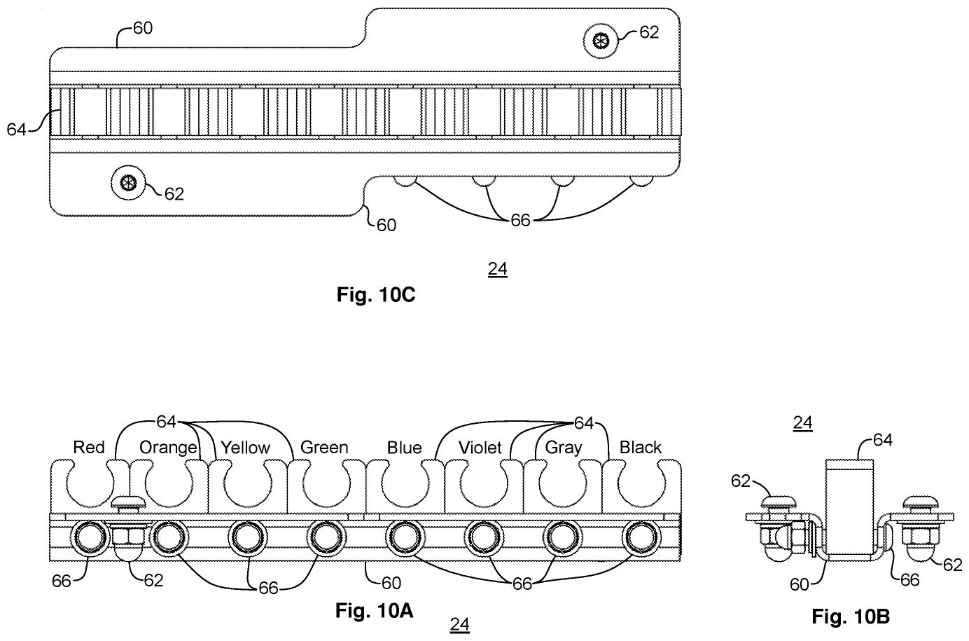

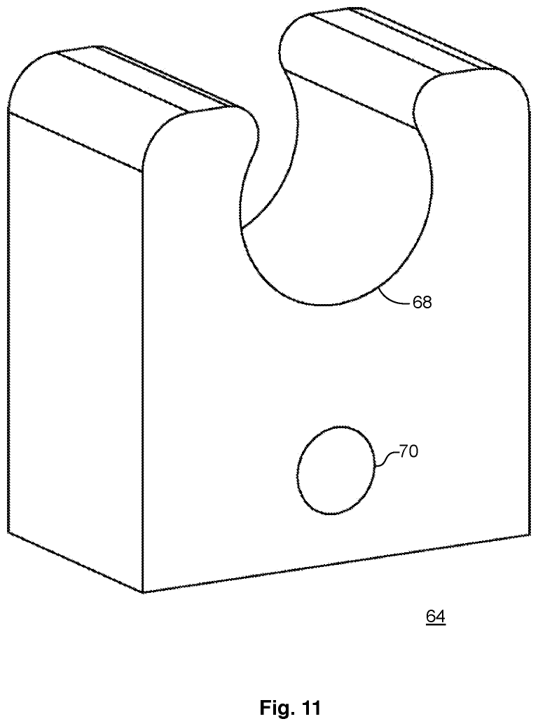

Reference is directed to FIGS. 10A, 10B, and 10C, which are a side view drawing, and end view drawing, and a top view drawing, respectively, of a tube support bracket assembly 24 according to an illustrative embodiment of the present invention. The assembly 24 includes a formed channel 60, as illustrated, which is fabricated from stainless steel sheet in the illustrative embodiment. Other materials may be employed to fabricate the formed channel, including other metals and polymeric materials, which may also be molded and extruded shapes. Plural retention fasteners 66 are inserted through the formed channel 60 and engage plural tube clips 64, which are oriented to route plural tubes (not illustrated) in parallel. The plural tube clips 64 are fabricated from a polymeric material, such as silicone rubber or UHMW polyethylene, which are each impregnated with a unique color. The colors may be placed in any order, which is dictated by a preplanned tube routine map that accommodates the particular process. The formed channel 60 is retained in a support fixture by plural fasteners 62. In this embodiment, the several fasteners 62, 66 are a socket head cap screws and acorn nuts, also referred to as crown hex nuts, that have a domed end on one side.

Reference is directed to FIG. 11, which is a perspective view drawing of a polymeric tube clip 64 according to an illustrative embodiment of the present invention. Each tube clip 64 includes a tube grip recess 68 into which a tube (not illustrated) is inserted. The resilience of the tube and/or the tube clip 64 enable insertion and retention of the tube in the tube recess 68. The tube clip 64 also includes a mounting hole 70 that a corresponding fastener is inserted through (see item 66 in FIG. 7 and FIG. 10).

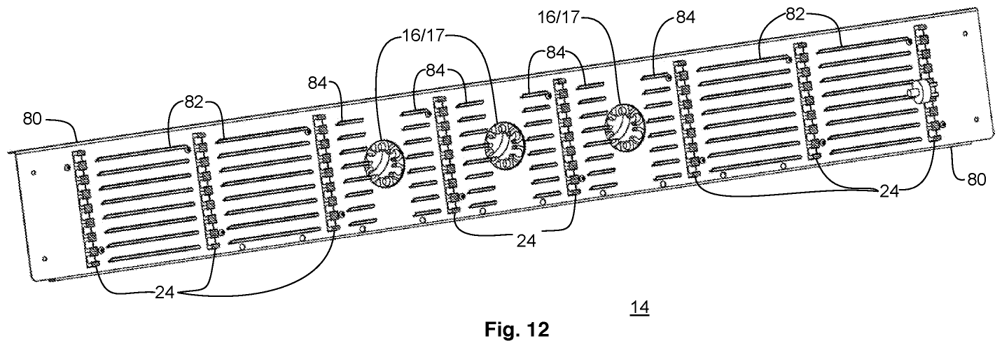

Reference is directed to FIG. 12, which is a perspective view drawing of a through-wall tube support fixture 14 according to an illustrative embodiment of the present invention. The fixture 14 is formed of a stainless steel plate 80, or other suitable material, and includes plural tubing shelves 82, 84 disposed on its front surface, as illustrated, to support plural tubes (not illustrated). Plural tube support bracket assemblies 24 are disposed through the plate 80, as described hereinbefore. In this embodiment, three holes 16 are formed through the plate 80, which provide a passageway to route tubes (not illustrated) through to the rear of the assembly 14, where they engage respective circular tube clip assemblies 17, which will be more fully described hereinafter. All of the tube support bracket assembles 24 and the circular tube clip assemblies 17 provide for plural uniquely colored tube clips to be inserted in a preplanned arrangement, as described hereinbefore.

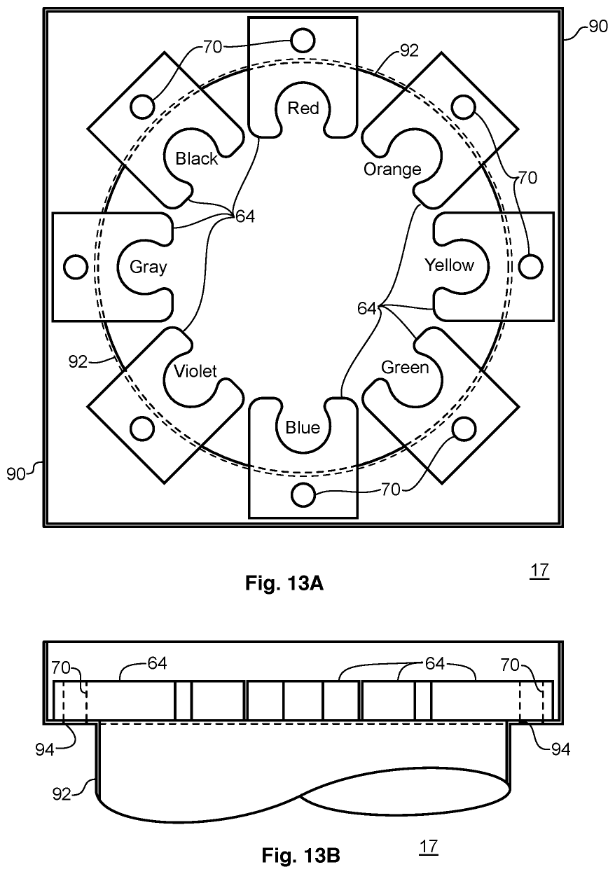

Reference is directed to FIGS. 13A and 13B, which are a side view drawing and a section view drawing, respectively, of a circular tube clip assembly 17 according to an illustrative embodiment of the present invention. A box structure is formed of stainless steel or other suitable material, and has a conduit 92 extending from it rear side. Plural holes 94 are formed though the box 90, which facilitate connection of plural tube clips 64 the the assembly 17 using mounting holes 70 in each tube clip 64, in a like manner described hereinbefore. As such, the plural tube clips 64 present a circular arrangement that lies within the area of the hole(s) in the through wall tube support fixture (see item 16 in FIG. 12).

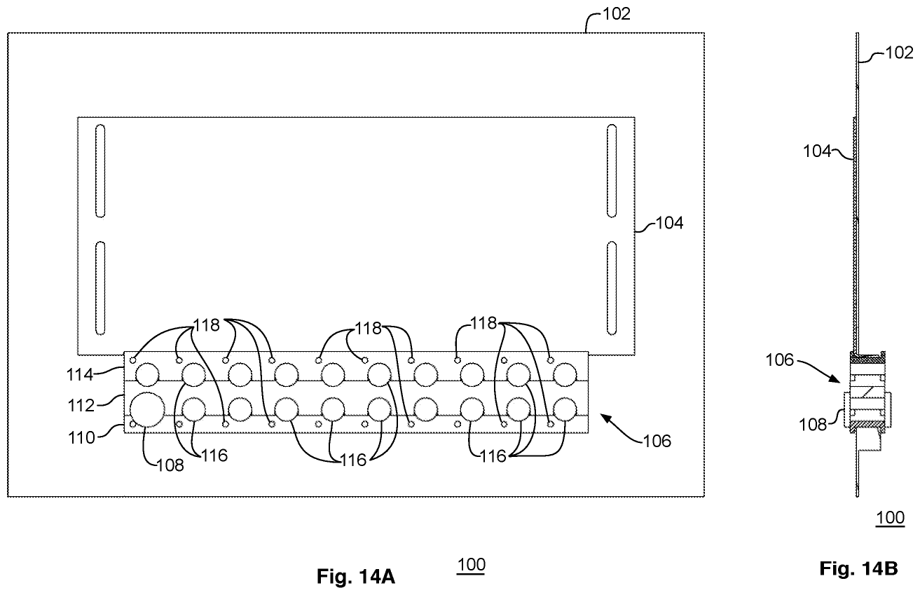

Reference is directed to FIGS. 14A and 14B, which are a side view drawing and section view drawing, respectively, of a doorway tube holder assembly 100 according to an illustrative embodiment of the present invention. This assembly 100 provides a means for routing plural tubes (not illustrated) into a space, with access through an access cover 104. In this embodiment, the assembly comprises a cover plate 102 with an access cover 104 in place, as illustrated. Adjacent the access cover 104 is a tube guide assembly 106, which provides plural passages 116 for tubes to pass through the assembly 100. In this embodiment there are two rows of ten passages 116, each of which may contain a tube (not illustrated) or a blocking spool 108 to seals an unused passages 116. Adjacent each tube passage 116 is a route marker hole 118 which is provided for insertion of a uniquely color-coded route marker (not illustrated, see FIG. 3B) to indicate to an installer, where tubes are to be routed. The route markers are each fabricated from one of several uniquely colored polymeric material with a stem that engages a hole 118 to retain it in place. The unique color options are shared amongst the clips and markers to coordinate installation of each tubing route.

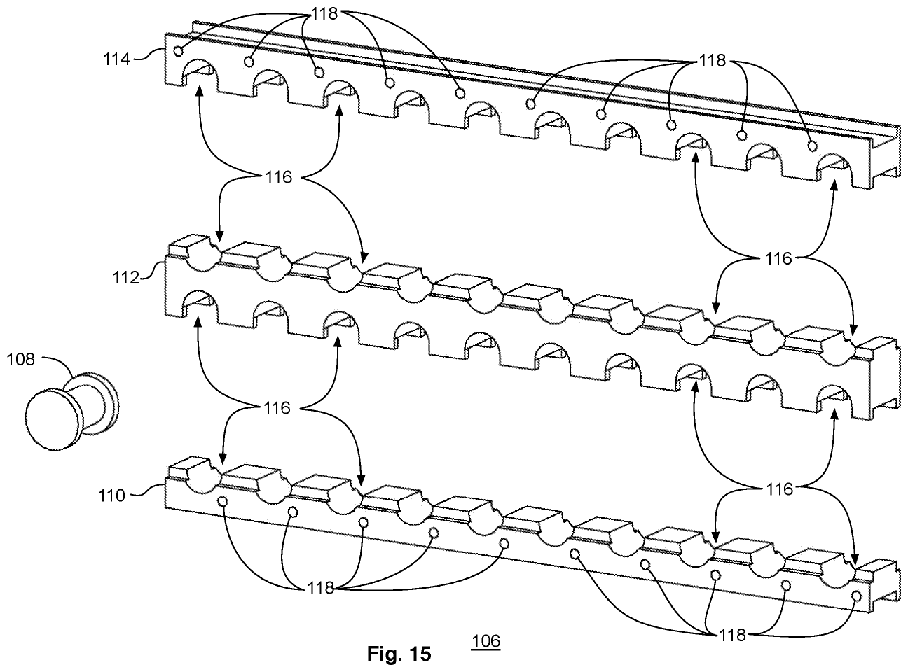

Reference is directed to FIG. 15, which is an exploded view drawing of a tube guide assembly 106 (reference FIGS. 14A and 14B) according to an illustrative embodiment of the present invention. The guide assembly is comprised of three formed members 110, 112, 114, as illustrated, which cooperatively join together to form the plural tube passages 116. The route marker holes 118 are from into these members 110, 114. The members 110, 112, 114 may be formed of a polymeric material, or other suitable material, as described hereinbefore.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A system for route labeling a process fixture to assist installation and support of plural tubes thereupon, the process fixture including plural support plates cooperatively arranged to support the plural tubes, the system comprising:
a first bracket fixed to a first support plate;
plural tube support clips selectively attachable to said first bracket, wherein at least one of said plural tube support clips displays one of plural unique colors;
a first route marker fixed to the process fixture along a planned route of a first tube, which displays a first color selected from said plural unique colors matching a first tube support clip selected from said plural tube support clips according to color, thereby enabling routing said first tube from the plural tubes according to said first color, and wherein
said first route marker does not support said first tube about the process fixture, but serves only to mark said planned route of said first tube.

2. The system of claim 1, and further comprising:
a first route indicator, which is a second tube support clip attached to a second bracket fixed to the process fixture, which also displays said first color, and wherein
said first tube is engaged with said first tube support clip and said said first route indicator.

3. (canceled)

4. The system of claim 3, and wherein:
said route marker is fabricated from a polymeric material having a stem, which is inserted through a hole in the process fixture.

5. The system of claim 1, and wherein:
said first route marker is a tube ring, which also displays said first color, and which is engaged about an exterior surface of said first tube and wherein
said tube ring does not support said first tube about the process fixture, distinguishing it from said plural tube support clips.

6. The system of claim 1, and wherein:
said plural tube support clips include mounting holes, and wherein
a portion of said plural tube support clips are attached to said first bracket with a fastener inserted through said mounting holes.

7. (canceled)

8. The system of claim 1, and wherein:
said first bracket engages a slotted opening in the first support plate, which thereby presents said plural tube support clips through said slotted opening in a manner that the plural tubes lie substantially flush with a support surface of the first support plate.

9. The system of claim 1, and wherein:
said plural tube support clips fabricated from a polymeric material.

10. The system of claim 1, and wherein:
said first bracket is substantially linear, and wherein
said plural tube support clips arranged side-to-side along said first bracket such that plural tubes supported thereby are arranged in parallel.

11. The system of claim 1, and wherein;
said first bracket is circular, and disposed about a hole in said first support plate, such that the plural tubes pass through the hole in the first support plate.

12. A method of route labeling a process fixture,
having plural support plates, for assisting installation of plural tubes thereupon, using brackets, plural tube support clips each displaying one of plural unique colors, and route indicators or route markers, each also displaying one of the plural unique colors, and wherein the route markers do not support the plural tube about the process fixture, but serve only to mark planned routes of individual tubes, the method comprising the steps of:
fixing a first bracket to a first support plate;
selecting a first tube support clip according to a first color;
attaching the first tube support clip to the first bracket;
selecting a first route marker according to the first color;
disposing the first route marker upon the process fixture;
engaging a first tube with the first tube support clip, and
routing the first tube about the process fixture to the first route marker according to the first color, and thereby
providing route labeling for the first tube according to the first color.

13. The method of claim 12, and wherein the first route indicator is a second tube support clip, which also displays the first color, and further comprising the steps of:
attaching a second bracket to the process fixture;
attaching the second tube support clip to the second bracket, and
engaging the first tube with the first tube support clip and the second tube support clip.

14. The method of claim 12, and wherein the route marker also display the first color, and further comprising the steps of:
fixing the first route marker to the process fixture along a planned route of the first tube, and
routing the first tube along the first route marker according to the first color.

15. The method of claim 14, and wherein the route marker is fabricated from a polymeric material having a stem, and further comprising the step of:
inserting the stem of the route market through a hole the process fixture.

16. The method of claim 14, and wherein the route marker is a first tube ring, which also displays the first color, but does not support the first tube about the process fixture, distinguishing it from the plural tube support clips, and further comprising the step of:
engaging the first tube ring about an exterior surface of the first tube.

17. The method of claim 12, and wherein a slotted opening is formed through the first support plate, and further comprising the steps of:
engaging the first bracket in the slotted opening, thereby presenting the plural tube clips through the slotted opening in a manner that the plural tubes lie substantially flush with a support surface of the first support plate.

18. The method of claim 12, and wherein the first bracket is substantially linear, and further comprising the steps of:
arranging the plural tube support clips side-to-side along the first bracket such that plural tubes supported thereby are arranged in parallel.

19. The method of claim 12, and wherein the first bracket is circular about a hole in the first support plate, and further comprising the steps of:
disposing the plural tube support clips about the circular hole in the first support plate, such that the plural tubes pass through the hole in the first support plate.
